(19) United States
(12) Patent Application Publication
(10) Pub. No.: US 2009/0296786 A1
(43) Pub. Date: Dec. 3, 2009

(54) METHOD AND SYSTEM FOR ADAPTIVE DUPLICATED FILTERS AND INTERFERENCE CANCELLATION

(76) Inventors: Daniel Massicotte, Trois-Rivieres (CA); Messaoud Ahmed-Ouameur, Trois-Rivieres (CA); Francois Nougarou, Trois-Rivieres (CA)

Correspondence Address: FAY KAPLUN & MARCIN, LLP, 150 BROADWAY, SUITE 702, NEW YORK, NY, 10038, US

(21) Appl. No.: 12/158,177

(22) PCT Filed: Dec. 21, 2006
(86) PCT No.: PCT/CA2006/002106

§ 371 Date: Dec. 9, 2008

Related U.S. Application Data
(60) Provisional application No. 60/752,052, filed on Dec. 21, 2005.

(51) Int. Cl. H04B 1/707

(52) U.S. Cl. 375/148; 375/E01.02

(57) ABSTRACT

A method and device substantially cancel at least Multiple Access Interference (MAI) and Inter-Symbol Interference (ISI) while detecting a received spread spectrum signal in a multi-user communication system. For that purpose, a plurality of stages are formed, each comprising processing the received spread spectrum signal through an interference cancelling function to produce an essentially MAI- and ISI-free signal, and processing the essentially MAI- and ISI-free signal through a reconstruct received spread spectrum signal function to produce a received spread spectrum signal essentially free from MAI and ISI. The plurality of stages are cascaded to successively process the spread spectrum signal and improve cancellation of MAI and ISI from the spread spectrum signal.

### FIELD OF THE INVENTION

The present invention generally relates to digital telecommunications. More specifically, but not exclusively, the present invention is concerned with a method and system for adaptive duplicated filters and interference cancellation in direct-sequence code division multiple access (DS-CDMA) communication systems.

### BACKGROUND OF THE INVENTION

CDMA (Code Division Multiple Access) is a well-known multiple access technique for accessing a multi-user communication system. Unlike TDMA or FDMA, in CDMA systems the entire bandwidth is used at the same time by the plurality of users. The transmitted data of each user is therefore differentiated from one another by using a specific coding sequence, such as a pseudo-noise (PN) sequence, which is unique to each user. CDMA systems perform well in an environment with interference. However, its performance will degrade after a certain maximum level of interference has been reached.

Multi-user signal processing refers to the joint processing of the signals of all the users in a system. This joint processing is very effective, since CDMA systems are interference-limited, and provides significant performance improvement compared to traditional single-user processing [17], [21], [22] used in practice. The interest in multi-user signal processing for CDMA stemmed from Verdú's seminal work in [16], where he proposed and analyzed the optimal multi-user device, or the Maximum Likelihood (ML) sequence device. Unfortunately, this device has a complexity exponential with the number of users. Therefore, over the last two decades, research in this area has focused on several sub-optimal solutions [18], [19], [15], [23], [20], [24], [27] which have a complexity linearly increasing with the number of users and are more feasible to implement.

In DS-CDMA systems, the receiver at a base station (uplink) is designed to efficiently combat multiple access interferences (MAI) as well as inter-symbol interferences (ISI) [1]-[3]. Conventional receiver, such as the Rake, ignores MAI and considers them as additive white Gaussian noise (AWGN) while detecting the user of interest [2]-[3]. Accordingly, the Rake receiver suffers substantially from performance degradation as the number of user increases. Therefore, many suggestions flew to provide efficient solution to overcome MAI and ISI through multi-user detection schemes [2]-[9]. Other sub-optimal methods have been proposed. One possible classification of decoding is to assign the MUD (Multi-User Detection) method to one of the two major classes whether or not the channel estimates are required. Namely, direct methods require channel estimates in terms of channel's attenuations and delays to perform the detection process [8] and [9]. On the other hand, indirect techniques resort to some adaptive process to design the receiver using the possibly available training information [4]-[7]. To improve the performance-complexity tradeoff, MUD methods based on direct and indirect process are proposed [9], [6], [14] and [28].

Owing to their reduced computational complexity, indirect (adaptive) technique [4]-[7] will take the major part of this application. The computational complexity saving inherent in most adaptive methods, such as least mean square (LMS) or other techniques [10]-[13], stem from simple multiplication-addition operations wherein matrix manipulations (matrix-matrix, matrix-vector multiplications and/or matrix inversion, etc.) are involved. This approach supports the Very Large-Scale Integration (VLSI) implementation in a pipeline structure to maximize the number of users detected in a device [14]. The cost of matrix manipulations becomes more expensive in time varying channels wherein the channel attenuations' variations dictate the frequency of the MUD's parameter update [3] (correlation matrices for MAI suppression in parallel interference cancellation techniques for instance).

### SUMMARY OF THE INVENTION

An object of the present invention is therefore to provide a method and device having low implementation complexity in VLSI technology (for example DSP, FPGA, ASIC) and improved efficiency in substantially cancelling at least MAI and ISI in a multi-user communication system such as, for example, a CDMA system.

More specifically, in accordance with the present invention, there is provided a method for substantially cancelling at least Multiple Access Interference (MAI) and Inter-Symbol Interference (ISI) while detecting a received spread spectrum signal in a multi-user communication system. The method comprises forming a plurality of stages, each comprising: processing the received spread spectrum signal through an interference cancelling function to produce an essentially MAI- and ISI-free signal; and processing the essentially MAI- and ISI-free signal through a reconstruct received spread spectrum signal function to produce a received spread spectrum signal essentially free from MAI and ISI. The method also comprises cascading the plurality of stages to successively process the spread spectrum signal and improve cancellation of MAI and ISI from the spread spectrum signal.

The present invention is also concerned with a device for substantially cancelling at least Multiple Access Interference (MAI) and Inter-Symbol Interference (ISI) while detecting a received spread spectrum signal in a multi-user communication system. The device comprises a plurality of stages, each comprising: means for filtering the received spread spectrum signal through an interference cancelling function to produce an essentially MAI- and ISI-free signal; and means for processing the essentially MAI-free signal through a reconstruct received spread spectrum signal function to produce a received spread spectrum signal essentially free from MAI and ISI. The plurality of stages are cascaded to successively process the spread spectrum signal and improve cancellation of MAI and ISI from the spread spectrum signal.

The present invention further relates to a device for substantially cancelling at least Multiple Access Interference (MAI) and Inter-Symbol Interference (ISI) while detecting a received spread spectrum signal in a multi-user communication system. This device comprises a plurality of stages, each comprising: at least one adaptive filter for filtering the received spread spectrum signal through an interference cancelling function to produce an essentially MAI and ISI-free signal; and an interference cancellor, connected to the at least one adaptive filter, for processing the essentially MAI- and ISI-free signal through a reconstruct received spread spectrum signal function to produce a received spread spectrum signal essentially free from MAI and ISI. The plurality of stages are cascaded to successively process the spread spectrum signal and improve cancellation of MAI and ISI from the spread spectrum signal.

The present invention is still concerned with a device for substantially cancelling at least Multiple Access Interference (MAI) and Inter-Symbol Interference (ISI) while detecting a received spread spectrum signal in a multi-user communication system. The device comprises a set of adaptive filters for filtering the received spread spectrum signal through an interference cancelling function to produce an essentially MAI- and ISI-free signal, wherein at least one of the adaptive filters is assigned to each user.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a block diagram illustrating the transmission scheme of multi-users' data to one receiving antenna in accordance with a non-restrictive illustrative embodiment of the present invention;

FIG. 2 is a block diagram illustrating an adaptive duplicated filter and interference cancellation in a multi-stage structure receiver for DS-CDMA systems in accordance with a non-restrictive illustrative embodiment of the present invention;

FIG. 3 is a block diagram illustrating a single stage of an adaptive duplicated filter and interference cancellation of the multi-stage structure receiver for DS-CDMA systems of FIG. 2;

FIG. 4 is a block diagram illustrating an adaptive filter structure for DS-CDMA systems of FIG. 2 during the adaptation phase;

FIG. 5 is a flow chart illustrating the adaptation process of the adaptive filter of FIG. 4;

FIG. 6 is a flow chart illustrating the detection phase of the adaptive duplicated filter and interference cancellation in a multi-stage structure receiver for DS-CDMA systems of FIG. 3;

FIG. 7 is a block diagram illustrating an adaptive duplicated filter and interference cancellation in a decision feedback structure receiver for DS-CDMA systems in accordance with a non-restrictive illustrative embodiment of the present invention;

FIG. 8 is a block diagram illustrating an adaptive duplicated filter and interference cancellation in a multi-stage structure receiver for DS-CDMA systems in a multiple receiving antenna environment in accordance with another non-restrictive illustrative embodiment of the present invention;

FIG. 9 includes graphs illustrating experimental results for 64 kb/s (a) and 144 kb/s (b) using the adaptive duplicated filter and interference cancellation in a multi-stage structure receiver for DS-CDMA systems of FIG. 2; and

FIGS. 10a and 10b show graphs of required number of FA for ADIC and DF-soft-MPIC relative to the Rake receiver with N_{c}=3 and N_{q}=16 bits for OVSF=16, 8 and 4, where in FIG. 10a 15 updates per frame for both methods are performed and in FIG. 10b 15 and 8 updates per frame respectively for DF-Soft-MPIC and ADIC are performed.

It will be noted that throughout the appended drawings, like features are identified by like reference numerals.

### DETAILED DESCRIPTION

### System Model

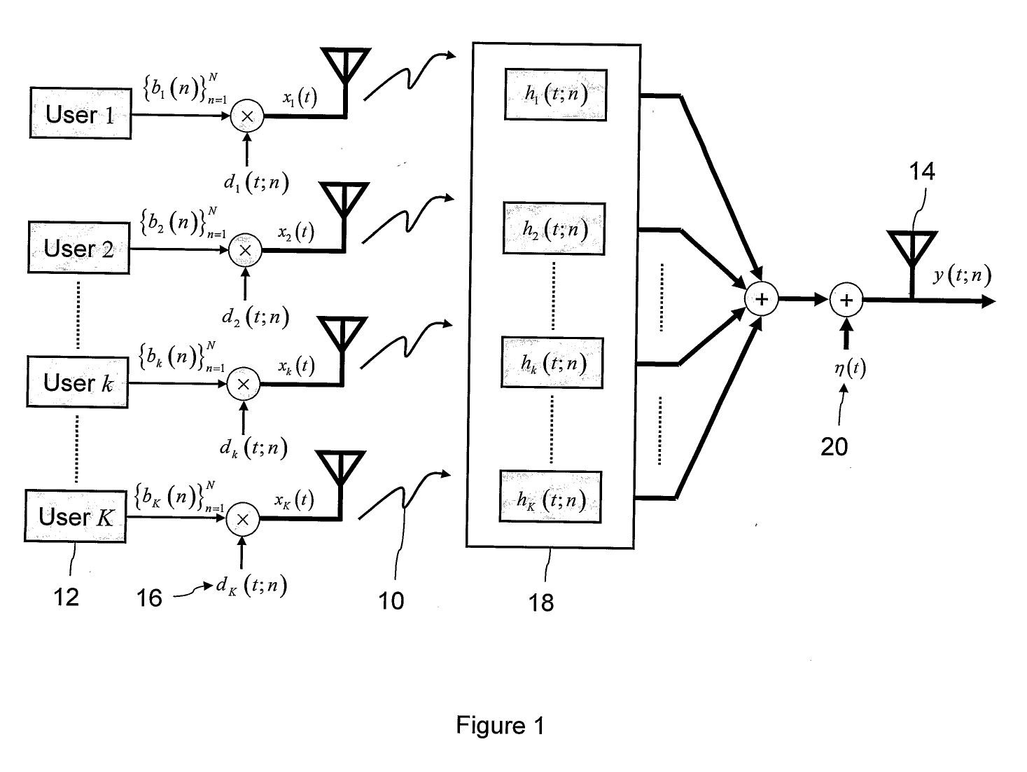

FIG. 1 illustrates an uplink data transmission 10 from K mobile units (or users) such as 12 to a base station equipped with a receiving antenna array 14. It should be noted that, in the illustrative embodiment of FIG. 1, only one receiving antenna 14 will be considered for concision purposes. However, the use of a plurality of receiving antennas 14 is considered to be under the scope of the present invention and will be described herein below.

In FIG. 1, the information sequence of the k^{th} user 12 is denoted as {bₖ(n)}ₙ₌₁^{N}. After going through spectrum spreading, which is realized in a multiplication such as 16, the k^{th} user's transmitted baseband signal, carrying the information sequence {bₖ(n)}ₙ₌₁^{N}, can be written as:

$${x}_{k} ( t ) = {\sum }_{n = 1}^{N} {A}_{k} {b}_{k} ( n ) {d}_{k} ( t - nT ; n ) \qquad ( 1 )$$

where N is the number of symbols, Aₖ is the signal gain and bₖ(n) is the n^{th} symbol of duration T. bₖ(n) is assumed to belong to the alphabet Ξ such that Ξ={±1} for Binary Phase-Shift Keying (BPSK) signals, or Ξ={(±1±j)/\sqrt{2}} for Quaternary Phase Shift Keying (QPSK) signals. dₖ(t; n) corresponds to the spreading (scrambling) sequence for the n^{th} symbol, provided at the multiplication 16. It is given by:

$${d}_{k} ( t ; n ) = {\sum }_{l = 1}^{{N}_{c}} {c}_{k , l} ( n ) ψ ( t - {lT}_{c} ) \qquad ( 2 )$$

where N_{c}=T/T_{c} (by definition) determines the spreading factor (processing gain), with T_{c} being the duration of a chip or the spreading bit-time. c_{k,l}(n) is the l^{th} element of the spreading sequence for the n^{th} symbol with c_{k,l}(n)ε{(±1±j)/\sqrt{2}}. ψ(t) is a unit energy pulse shaping filter such as, for example, a raised cosine filter. As mentioned in the foregoing description, spreading of the spectrum of the baseband signal is performed at the multiplier such as 16.

The k^{th} user's spread spectrum signal, xₖ(t), is then transmitted to the receiving antenna 14 via radio frequencies and therefore goes through a wireless, multi-path fading channel 18.

A multi-path fading channel 18 is defined by an attenuation and a delay. More specifically, hₖ(t; n) is defined to be the k^{th} user's multi-path channel 18ₖ corresponding to the n^{th} symbol, and is given as follows:

$${h}_{k} ( t ; n ) = {\sum }_{p = 1}^{{P}_{k}} {h}_{k , p} ( n ) δ ( t - {τ}_{k , p} ) \qquad ( 3 )$$

where Pₖ is the number of paths, h_{k,p}(n) is the complex amplitude (attenuation) of the p^{th} path, τ_{k,p} is the propagation delay of the p^{th} path, and δ(t) is the Dirac impulse function.

The receiving antenna 14 collects all the signals, including noise and multi-path signals. Indeed, during transmission, the spread spectrum signals xₖ(t) get corrupted, for example by random noise, multi-path interferences and other interference signals. These interferences are represented by η(t) and are taken into account by the adder 20, which adds these interferences η(t) together with the transmitted signals xₖ(t) to form the received spread spectrum signal y(t; n). More specifically, from Equations (1) and (3) the total received spread spectrum signal y(t; n) at the receiving antenna 14 of the base station is written as:

$$y ( t ; n ) = {\sum }_{k = 1}^{K} {\sum }_{p = 1}^{{P}_{k}} {r}_{k , p} ( t - {τ}_{k , p} ; n ) + {\overline{r}}_{k , p} ( t - {τ}_{k , p} ; n ) + η ( t ) \qquad ( 4 )$$

where η(t) denotes the above mentioned interferences. It should be noted that the received spread signal y(t; n) as defined in Equation (4) includes a pilot-transmission signal r̅_{k,p}(t−τ_{k,p}; n) for synchronization and/or channel estimation purposes, which undergoes the same multi-path channel 18 as the information traffic bearing signal r_{k,p}(t−τ_{k,p}; n), which is defined as:

$$\begin{matrix}{\sum }_{p = 1}^{{P}_{k}} {r}_{k , p} ( t - {τ}_{k , p} ; n ) = {A}_{k} {b}_{k} ( n ) ( {h}_{k} ( t ; n ) ⊗ {d}_{k} ( t ; n ) ) \\ = {A}_{k} {b}_{k} ( n ) {\sum }_{p = 1}^{{P}_{k}} {h}_{k , p} ( n ) {d}_{k} ( t - nT - {τ}_{k , p} ; n ) \\ = {A}_{k} {b}_{k} ( n ) {Θ}_{k} ( t ; n )\end{matrix} \qquad ( 5 )$$

where Θₖ(t; n) represents the effective code assigned to the user k for coding the corresponding data. Equation (5) represents the temporal convolution (represented by [symbol] ) between the k^{th} user's spread sequence from Equation (2) at symbol instant n and the multi-path channel 18ₖ from Equation (3). In a more compact form, the received spread spectrum signal y(t; n) as defined in Equation (4), without the pilot-transmission signal, can be re-written as:

$$y ( t ; n ) = {\sum }_{n = 1}^{N} {\sum }_{k = 1}^{K} {A}_{k} {b}_{k} ( n ) {Θ}_{k} ( t ; n ) + η ( t ) \qquad ( 6 )$$

### Adaptive Duplicated Filter Plus Interference Cancellor (ADIC)

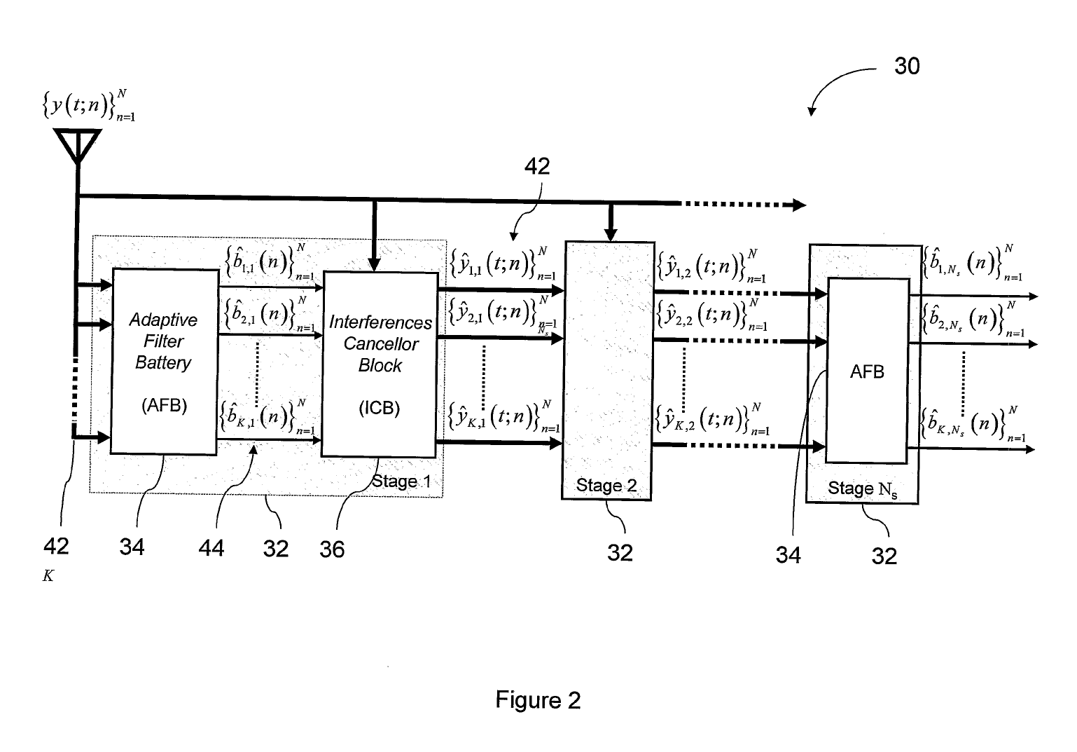

FIG. 2 illustrates a MUD system, and more specifically a multi-stage ADIC 30 having a number Nₛ of stages 32 serially connected to one another (cascaded) and receiving as input the received spread spectrum signal y(t; n). Each stage 32 consists of two distinct blocks 34 and 36, namely i) a battery of adaptive filters (AFB) 34 and ii) an interference canceller block (ICB) 36. However, in the non limitative example of FIG. 2, the last stage 32ₛ consists only of an AFB 34 for decoding the transmitted traffic information sequence of symbols; the last stage 32ₛ comprises no ICB 36. All the stages 32 contribute to combat, that is to substantially cancel both MAI (Multiple Access Interference) and ISI (Inter-Symbol Interference) [4]-[9].

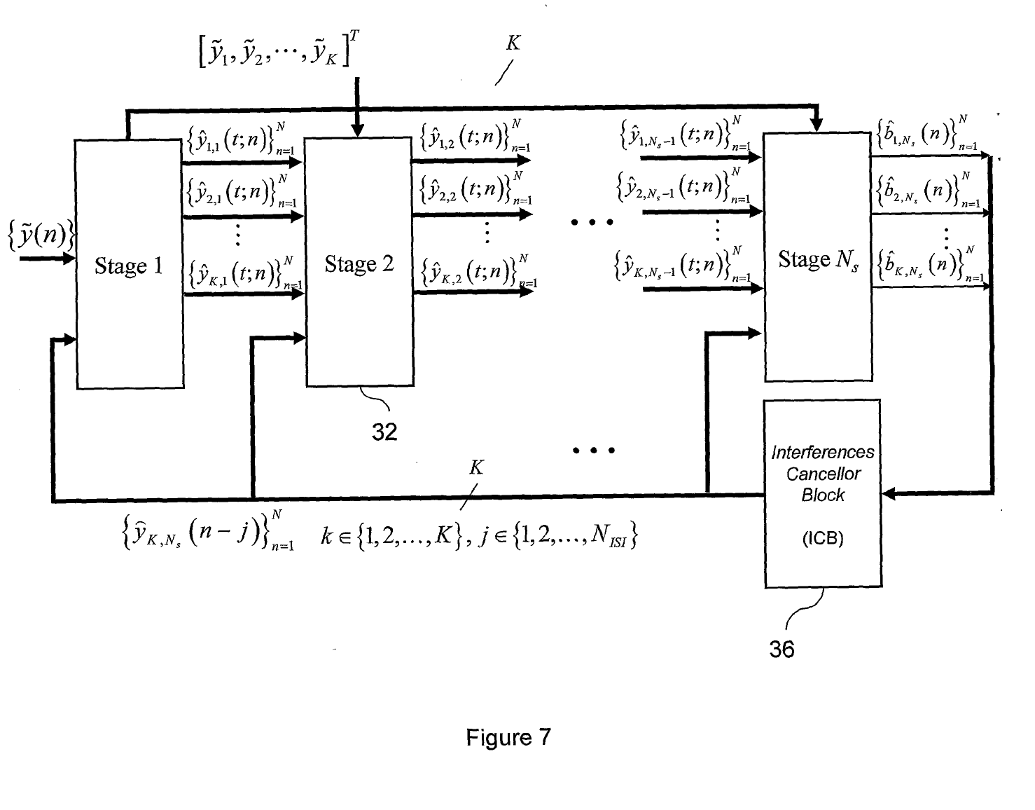

It is to be noted that a decision feedback can also be applied to the input of the multi-stage ADIC 30. The decision feedback can be implemented using a device such as the conventional Decision Feedback Equalizer (DFE) [16], [25]. The conventional Decision Feedback Equalizer (DFE) is otherwise well known to those of ordinary skill in the art and, for that reason, will not be further described in the present specification. A non limitative example of DFE is illustrated in FIG. 7.

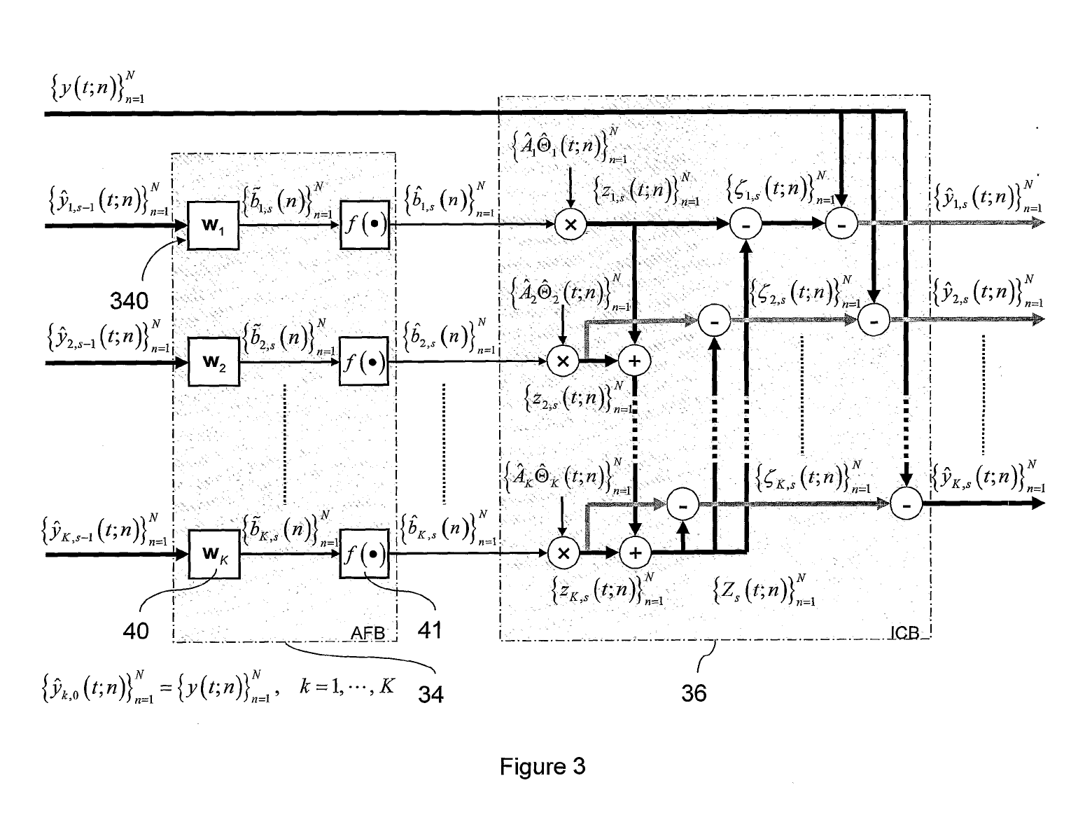

The AFB 34 of each stage 32 comprises filtering weights such as 40 (FIG. 3) that need to be adapted and adjusted so as to yield an optimum performance of the AFB 34, which is obtained when the filtering weights 40 converge to the inverse of the effective codes Θₖ(t; n) assigned to the user 12. Furthermore, the AFB 34 comprises an adaptive filter 340 (FIG. 3) assigned to each user 12, meaning that for a number K of users, the AFB 34 comprises K adaptive filters 340. The filtering weights 40 are therefore adjusted for each user before the transmission of the corresponding information data. Once their filtering weights 40 are adapted through the adaptation procedure that will be described herein below, the adaptive filter 340 assigned to a particular user is duplicated in the AFBs 34 over the rest of the stages 32. In other words, all the stages 32 share the same AFB 34 with the same adapted filtering weights 40, so that the adaptation procedure is done only once in the multi-stage ADIC 30.

The adaptive filter battery (AFB) 34 of the first stage 32₁ accepts as inputs 42 the received spread signal y(t; n) and outputs estimates 44 of the traffic information sequence. For the rest of the Nₛ stages 32, at a stage s for 1<s<Nₛ, the inputs 42 of the AFB 34 of this particular stage 32ₛ come from the outputs of the ICB 36 of the previous stage 32ₛ₋₁. The inputs 42 consist of essentially interference-free signals, since those signals have been processed through at least one stage 32 of MAI and ISI cancellation of the multi-stage ADIC 30, as illustrated in FIG. 2. Therefore, the greater is the number of stages 32, the better is the MAI and ISI cancellation.

The purpose of the AFB 34 is mainly to suppress ISI and MAI. Furthermore, the AFB 34 involves dispreading using the adapted filtering weights 40, since the AFB 34 uses as inputs the received spread spectrum signal y(t; n) or an estimated version thereof and outputs estimates of the information traffic sequence of the baseband signal.

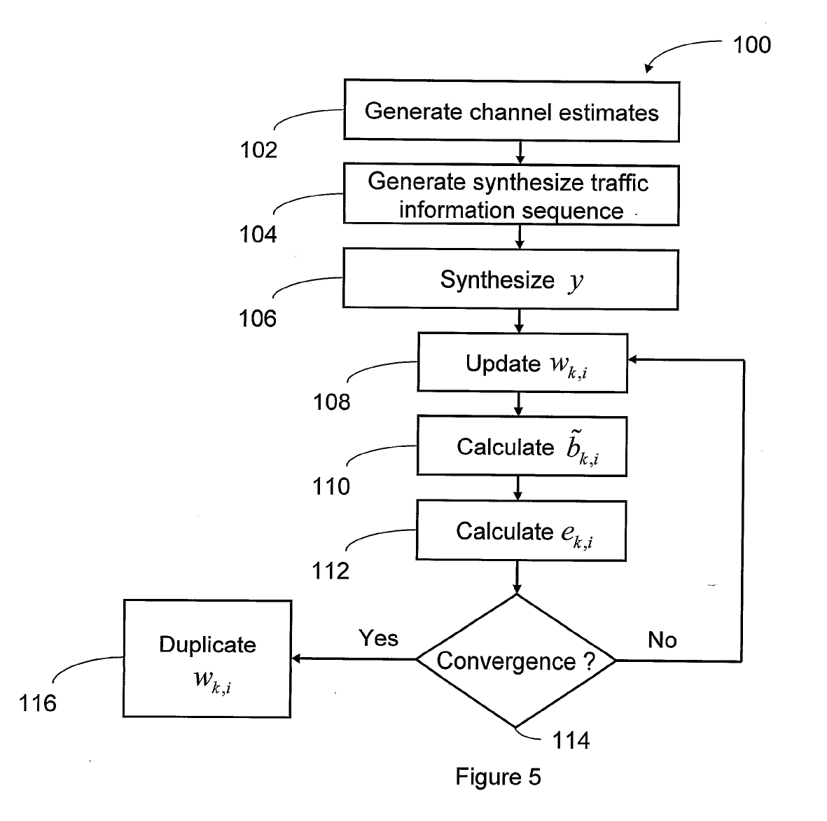

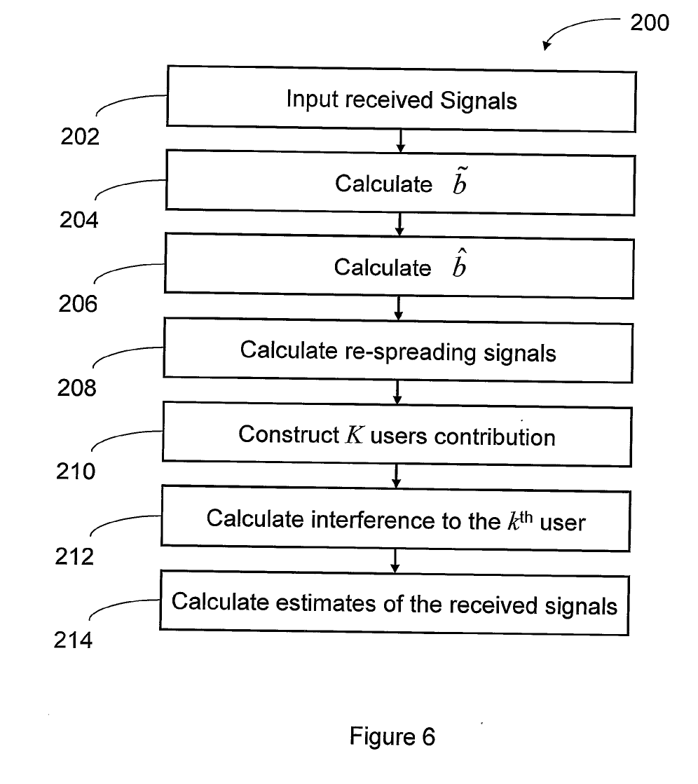

Furthermore, the AFB 34 comprises two operational phases i) an adaptation phase 100 as illustrated in FIG. 5, wherein the filter weights 40 are adaptively computed, and ii) a detection phase 200 (FIG. 6) for computing estimates of the received spread spectrum signal y(t; n) which also involves the ICB 36 as illustrated in FIG. 3.

### Adaptation Phase

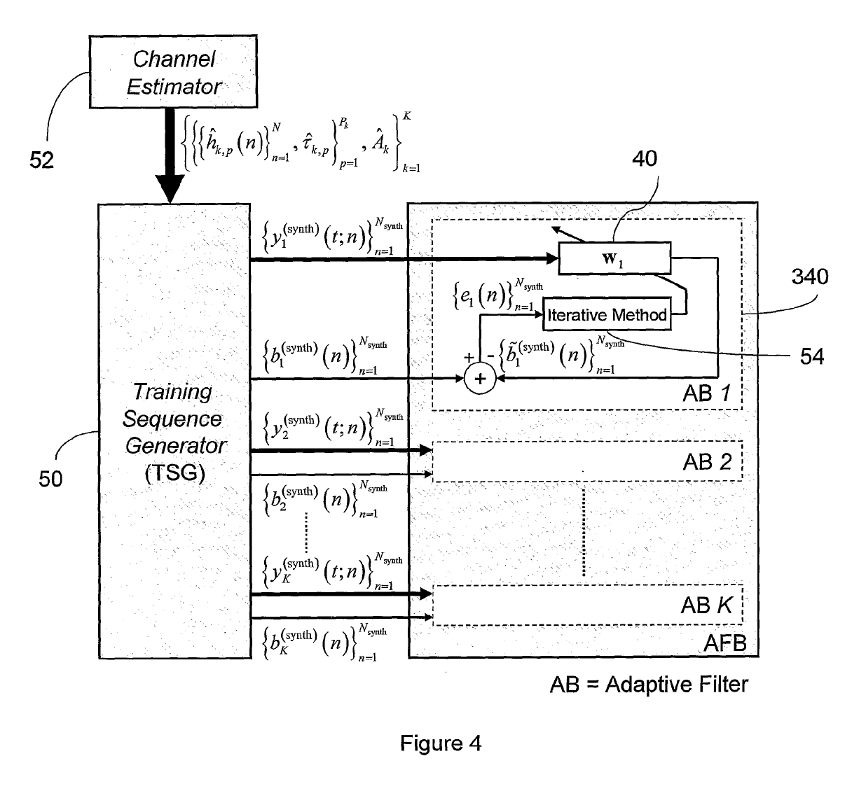

The adaptation phase 100 as illustrated in the flow chart of FIG. 5 corresponds to the process of designing the filtering weights 40 (weights w) of the AFB 34 for a part or all the users, recalling that one adaptive filter 340 is assigned to each user 12. FIG. 4 illustrates the structure of the adaptation phase which involves (i) a training sequence synthesis and (ii) the adaptation process itself for computing the filtering weights such as 40, more specifically the weights wₖ of the k^{th} user 12.

### A) Training Sequence Synthesis

In order to carry out the weight adaptation process, some required signals have to be first constructed. Most often (but not necessary limited to), weight update is performed based on a (stochastic) gradient technique using the error between the desired (target) signal and the filter output [10]. Therefore, training signals [4]-[6], [28] are needed and provided. However, it is well known that most, if not all, existing commercial DS-CDMA systems (WCDMA and CDMA 2000) do not provide such training signals [1]. Pilot-transmission signals are not considered in the present specification as they do not share the same effective code Θₖ(t; n) as the traffic information signals and it is limited in number of training data to assure the convergence in variant channel conditions.

From the above constraint requiring training signals, a training sequence generator (TSG) 50 is designed as illustrated in FIG. 4 (see [28]). The TSG 50 draws, for example randomly or using a given distribution, some training symbols denoted as bₖ^{(synth)}(n) for each user k, from the same alphabet set Ξ as the original traffic information symbols. Then, with the help of channel estimates given by a channel estimator 52, the TSG 50 synthesizes a received signal yₖ^{(synth)}(t; n) for each user k, as described in Equations (7)-(8):

$$\begin{matrix}{y}_{k}^{( synth )} ( t ; n ) = {\sum }_{p = 1}^{{P}_{k}} ( \begin{matrix}{r}_{k , p}^{( synth )} ( t - {\hat{τ}}_{k , p} ; n ) + \\ {\overline{r}}_{k , p}^{( synth )} ( t - {\hat{τ}}_{k , p} ; n )\end{matrix} ) + {η}^{( synth )} ( t ) & ( 7 ) \\ \begin{matrix}{\sum }_{p = 1}^{{P}_{k}} {r}_{k , p}^{( synth )} ( t - {\hat{τ}}_{k , p} ; n ) = {\hat{A}}_{k} {b}_{k}^{( synth )} ( n ) ( {\hat{h}}_{k} ( t ; n ) ⊗ {d}_{k} ( t ; n ) ) \\ = {\hat{A}}_{k} {b}_{k}^{( synth )} ( n ) {\sum }_{p = 1}^{{P}_{k}} {\hat{h}}_{k , p} ( n ) \\ {d}_{k} ( t - nT - {\hat{τ}}_{k , p} ; n ) \\ = {\hat{A}}_{k} {b}_{k}^{( synth )} ( n ) {\hat{Θ}}_{k} ( t ; n )\end{matrix} & ( 8 )\end{matrix}$$

where Âₖ, ĥ_{k,p}(n) and \hat{τ}_{k,p} are respectively estimate values of the signal gain Aₖ, the p^{th} path complex amplitude (attenuation) h_{k,p}(n), and the p^{th} path propagation delay τ_{k,p} provided by the channel estimator 52, which can be a well known channel estimator named Correlator (e.g. [30]) or more performing techniques (e.g. [29], [31]), for example. It should be noted that in Equation (7), the pilot-transmission signal r̅_{k,p}^{(synth)}(t−\hat{τ}_{k,p};n) as well as an additive noise η^{(synth)}(t) are also synthesized. It is worth mentioning that there is no restriction on the noise, which can be either a white or colored noise for example. For brevity purposes and without substantially affecting the results, Equation (8) describes only the traffic information signal r_{k,p}^{(synth)}(t−\hat{τ}_{k,p}; n) synthesis. As shown in FIG. 4, the generated (synthesized) sequence is of length N_{synth} symbols per user.

### B) Adaptive Methods

Once the synthesized sequences, yₖ^{(synth)}(t; n) and bₖ^{(synth)}(n), are generated for the user k, the adaptation process can proceed. It is recalled, from the description of the AFB 34, that each user 12 (user k) is assigned with unique filtering weights 40 written in a weighting vector wₖ to be adaptively calculated. Upon convergence, the filtering weights 40 of vector wₖ represent to some extent the inverse of the effective code Θₖ(t; n) from Equation (5). In addition, the dimensions of the weighting vector wₖ are shorter than that of Θₖ(t; n) which saves considerable computation complexity.

Also, as an example, in the context of the short-code WCDMA, the traffic spreading sequence is 256 chip long [1] (chip-by-chip multiplied scrambling and OVSF (Orthogonal Variable Spreading Factor channelization codes). Therefore, per pilot-symbol worth of time, N_{nc}=256/N_{c} effective codes are considered; this holds assuming that the channel 18 is constant during one pilot symbol duration. Therefore, for each user k, the weighting vector wₖ of the adaptive filter 340 includes N_{nc} sub-filters (not shown), each of them allowing to represent a short version of an inverse of the effective code Θₖ(t; n). At first, N_{SF}=2N_{c}, is considered to be the length of each sub-filter which yields a total filter length (per pilot-symbol duration) of N_{w}=N_{nc}N_{SF}. One can write wₖ[n]=[w_{k,1}^{T}[n], w_{k,2}^{T}[n], . . . , w_{k,Nnc}^{T}[n]]^{T}. The above specialization to short-code WCDMA signaling is extended to {Yₖ^{(synth)}(t; n)}ₙ₌₁^{N}^{_{synth}}, which is considered in a vector form (per user k, per sub-filter i, w_{k,i}[n], with 1<i [symbol] mod(n,N_{nc})≦N_{nc} where mod() is the modulo operation and 1≦n≦N) as:

$${y}_{k}^{( synth )} [ n ] = [ \begin{matrix}{y}_{k}^{( synth )} [ ( ( n - 1 ) {N}_{SF} - \frac{{N}_{SF}}{4} + 1 ) {T}_{c} + {\overline{τ}}_{k} ; n ] \\ {y}_{k}^{( synth )} [ ( ( n - 1 ) {N}_{SF} - \frac{{N}_{SF}}{4} + 2 ) {T}_{c} + {\overline{τ}}_{k} ; n ] \\ ⋮ \\ {y}_{k}^{( synth )} [ ( {nN}_{SF} - \frac{{N}_{SF}}{4} ) {T}_{c} + {\overline{τ}}_{k} ; n ]\end{matrix} ] \qquad ( 9 )$$

It can be observed that the term N_{SF}/4 centers (aligns) yₖ^{(synth)}[n] with the n^{th} symbol of the k^{th} user. The representation from Equation (9), for both wₖ and the synthesized input signal yₖ^{(synth)}[n], is in agreement with Equation (18).

Generally, the input signal {yₖ^{(synth)}(t; n)}ₙ₌₁^{N}^{_{synth}} of the adaptive filter 340 of user k is complex valued. A reduced complexity implementation for BPSK signals (mostly in the case of WCDMA systems) can be considered [13]. This complexity reduction is achieved by representing the input of the adaptive filter 340 as a vector composed of the real, real(x), and imaginary, imag(x), parts,

$${\breve{y}}_{k}^{( synth )} [ n ] {-}^{Δ} {[ {real ( {y}_{k}^{( synth )} [ n ] )}^{T} , {imag ( {y}_{k}^{( synth )} [ n ] )}^{T} ]}^{T} .$$

The vector length may appear to be doubled but the benefit of such representation manifests as a reduced arithmetic complexity [13]. In this case, the sub-filter length would be N_{SF}=4N_{c}.

Weight adaptation can be implemented using many adaptive techniques such as LMS and RLS (Recursive Least Square), which are iterative techniques. For example, according to the LMS adaptation rule, the weight adaptation process of the i^{th} sub-filter of the k^{th} user is performed using Equations (10)-(12). Once the synthesized received signal is constructed and the synthesized traffic information sequence is generated, both of them are sent to the corresponding adaptive filter 340. Note that the synthesized traffic information sequence constitutes the desired or target symbols that the filter should reproduce. As illustrated in FIG. 4, upon receiving the synthesized received signal and synthesized traffic information sequence, the adaptive filter 340 first computes the estimate \tilde{b}_{k,i}^{(synth)}(n) of the desired symbols using Equation (10). This estimate \tilde{b}_{k,i}^{(synth)}(n) forms the output of the sub-filter i. Once the estimate \tilde{b}_{k,i}^{(synth)}(n) is computed, it is compared to the synthesized traffic information sequence b_{k,i}^{(synth)}(n) and an error e_{k,i}^{(synth)}(n) between the two compared signals is outputted according to Equation (11). Then, this error is used as shown in Equation (12) for updating the weighting vector wₖ of the filtering weights 40 for the next iteration of the iterative method 54 in FIG. 4. The Equations (10)-(12) are given as follows:

\tilde{b}_{k,i}^{(synth)}(n)=w_{k,i}^{H}[n]yₖ^{(synth)}[n] (10)

e_{k,i}^{(synth)}(n)=bₖ^{(synth)}(n)−\tilde{b}_{k,i}^{(synth)}(n) (11)

w_{k,i}[n+1]=w_{k,i}[n]+μₖyₖ^{(synth)}[n]e_{k,i}^{(synth)}(n) (12)

wherein \tilde{b}_{k,i}^{(synth)}(n) is a soft estimate of the n^{th} bit at the i^{th} filter output, e_{k,i}^{(synth)}(n) is the error between \tilde{b}_{k,i}^{(synth)}(n) and the desired, synthesized symbol bₖ^{(synth)}(n) and μₖ is the adaptation step-size.

Regarding the LMS adaptation rule, it presents some advantages and drawbacks. The low arithmetic complexity presents one major advantage. However, as the input signal dynamics vary, since DS-CDMA signals are function of the SNR (Signal-to-Noise Ratio), multi-path channels, Doppler shifts, number of users K, etc., the adaptive step-size μₖ should be adjusted accordingly, which is a difficult task to do. Moreover, for achieving an asymptotic convergence, longer training sequences are required. Therefore, it would be advantageous to think of a self step-size adapting technique, in order to track the variations and dynamics of the input signal.

For example, variants of LMS and NLMS (Normalized LMS), such as SM-NLMS (Set Membership NMLS) [11] and SM-PU-NLMS (Set Membership Partial Update NLMS) [12], as well as the genetic algorithms [7], represent potential techniques for computing the weights 40. The adaptation process according to the SM-NLMS method is given by Equations (13)-(15). The main difference resides in the step of updating the weighting vectors and in the calculation of the adaptation step-size μₖ as it can be seen in Equations (14) and (15). The method SM-NLMS provides an excellent performance-complexity trade-off, at a convergence speed superior to the NLMS technique, thanks to a self adapting mechanism as given in Equation (15) for the step-size μₖ. The Equations (13)-(15) are given as follows:

$$\begin{matrix}{e}_{k , i}^{( synth )} ( n ) = {b}_{k}^{( synth )} ( n ) - {{w}_{k , i} [ n ]}^{H} {y}^{( synth )} [ n ] & ( 13 ) \\ {w}_{k , i} [ n + 1 ] = {w}_{k , i} [ n ] + {μ}_{k , i} ( n ) \frac{{e}_{k , i}^{( synth )} ( n ) {y}^{( synth )} [ n ]}{{{y}^{( synth )} [ n ]}^{H} {y}^{( synth )} [ n ]} & ( 14 ) \\ {μ}_{k , i} ( n ) = \{ \begin{matrix}1 - \frac{λ}{\vert {e}_{k , i}^{( synth )} ( n ) \vert} , & if \vert {e}_{k , i}^{( synth )} ( n ) \vert > λ \\ 0 , & otherwise .\end{matrix} & ( 15 )\end{matrix}$$

Similarly to LMS, Equation (13) computes the error between the filter output and the desired symbol. Equation (14) describes the filtering weights 40 update process. However, unlike LMS, the step size, μ_{k,i}(n) is dynamically conditional to a preset value λ. Equation (15) allows to establish two facts: (i) the term 1−λ/|e_{k,i}^{(synth)}(n)| is always less than 1 if |e_{k,i}^{(synth)}(n)|>λ, so that SM-NLMS is inherently stable, and (ii) otherwise μ_{k,i}(n) is set equal to 0 which alleviates some computational complexity. One possible choice is to have λ=0.005 so as to use almost all available synthesized training symbols. On the other hand, a value of λ=0.07 would trade-off some performance for a lower complexity, as established by the fact (ii).

Turning now to FIG. 5, the steps of the adaptation phase 100 can be summarized as follows.

First, during operation 102, the channel estimates (Âₖ, ĥ_{k,p}(n) and \hat{τ}_{k,p}) are generated by the channel estimator 52.

During operation 104, the TSG 50 generates the synthesized traffic information symbols bₖ^{(synth)}(n).

Then, during operation 106, the TSG 50 constructs a received synthesized signal yₖ^{(synth)}(t; n) from the channel estimates and the synthesized traffic information symbols bₖ^{(synth)}(n).

During operation 108, the filtering weights 40 are updated. At the very beginning of the adaptation process 100, the weights 40 are given initial values used for the first update.

Then, during operation 110, an estimate of the synthesized traffic information symbol \tilde{b}_{k,i}^{(synth)}(n) is calculated according to Equation (10).

During operation 112, an error between the generated traffic information symbols bₖ^{(synth)}(n) and the estimated traffic information symbol \tilde{b}_{k,i}^{(synth)}(n) is calculated.

During operation 114, the filtering weights 40 are checked for convergence. If the error is zero or negligible or the number of iteration is attained, which means that the filtering weights 40 are converging to a stable value, then the adaptation is completed.

Therefore, during operation 116, the values of the filtering weights 40 are duplicated over all the other stages 32 of the multi-stage ADIC 30.

However, if the error is non-zero (operation 114), the adaptation process 100 goes back to step 108 for updating the filtering weights 40 according to Equation (12). Then, the adaptation process 100 proceeds to the subsequent steps and loops back until the convergence of the filtering weights 40 is achieved.

Once the AFB 34 is correctly designed and the filtering weights 40 are properly adapted, the multi-stage ADIC 30 is ready for detection and decoding of the transmitted signals. The detection phase involves both the AFB 34 and the ICB 36 and will be described herein below.

### Detection Phase

Referring back to FIG. 2, during the detection phase, the AFB 34 receives as inputs 42 either the received spread spectrum signal {y(t; n)}ₙ₌₁^{N} of Equation (4) or the K estimated signals {ŷ_{k,s}(t; n)}ₙ₌₁^{N}(1≦k≦K and 1≦S≦Nₛ where Nₛ is the total number of stages 32) obtained from the previous stage 32ₛ₋₁. These inputs 42 are sampled at a chip rate. However, oversampling may also be used. Indeed, these signals are constructed according to Equations (1) and (2). The outputs 44 of the AFB 34 are estimates of the traffic information symbols denoted by {\hat{b}_{k,s}(n)}ₙ₌₁^{N}.

Since each stage 32 is similar, only one such stage 32 will be described. As shown in FIG. 3, the s^{th} stage 32 comprises the AFB 34 and ICB 36, with 1≦S≦Nₛ. Note that the AFB 34 of all the stages 32 is the same since they have been duplicated after the adaptation phase. Therefore, the index s is omitted in the notation.

A) Adaptive Filter Battery (AFB)

Unlike the other stages 32, for the first stage 32₁, all the input signals 42 (FIG. 2) of the AFB 34, denoted by {ŷ_{k,0}(t; n)}ₙ₌₁^{N}, are set equal to the total received spread spectrum signal given by Equation (4), i.e.,

{{ŷ_{k,0}(t;n)}ₖ₌₁^{K}}ₙ₌₁^{N}={y(t;n)}ₙ₌₁^{N} (16)

For a given user k, in order to describe the operations in the AFB 34 at stage 32ₛ, a vectorial representation of the estimated input 42 of the corresponding adaptive filter 340 from stage s−1, {ŷ_{k,s-1}(t; n)}ₙ₌₁^{N} is used. The estimated input 42 comes from the previous stage 32ₛ₋₁ as mentioned previously, and is essentially free from MAI and ISI, thanks to the previous stage 32ₛ₋₁. Accordingly, the estimated input 42 from stage 32ₛ₋₁ can be written as:

$${\hat{y}}_{k , s - 1} [ n ] = [ \begin{matrix}{\hat{y}}_{k , s - 1} [ ( ( n - 1 ) {N}_{w} + 1 ) {T}_{c} - {\overline{τ}}_{k} ; n ] \\ {\hat{y}}_{k , s - 1} [ ( ( n - 1 ) {N}_{w} + 2 ) {T}_{c} - {\overline{τ}}_{k} ; n ] \\ ⋮ \\ {\hat{y}}_{k , s - 1} [ ( {nN}_{w} ) {T}_{c} - {\overline{τ}}_{k} ; n ]\end{matrix} ] \qquad ( 17 )$$

It is to be noted that the inputs 42 from Equation (17) are time-aligned at τ̅ₖ, corresponding to a given path delay of the k^{th} user's channel 18 associated to user k. The choice may coincide with any delay or possibly with the strongest path's delay. The latter choice corresponds to the simplest structure. For achieving such structure, one can consider one filter per path wherein each filter input is synchronized with an appropriate path delay.

In the s^{th} stage 32 of the k^{th} user, a first raw output of the adaptive filter 340, denoted as \tilde{b}_{k,s}(n), is described in Equation (18) while the final and refined output 44, \hat{b}_{k,s}(n), which is obtained by using a decision function, is given by Equation (19):

\tilde{b}_{k,s}(n)=wₖ^{H}ŷ_{k,s-1}[n] (18)

\hat{b}_{k,s}(n)=f(\tilde{b}_{k,s}(n)) (19)

wherein wₖ=[wₖ(1), . . . , wₖ(N_{w})]^{T} represents the k^{th} user's filter weights 40 in a vector form, having dimensions such as dim(wₖ)=N_{w}×1. ƒ() (identified by reference 41 in FIG. 3) in Equation (19) is a decision function, for example, the signum function in case of a hard decision function, or a tangent-hyperbolic or any other relevant function for a soft decision function [8]. The final output 44 (FIG. 2), corresponding to the estimate of the traffic information symbols are given by Equation (20):

$${\hat{b}}_{k , s} ( n ) = \{ \begin{matrix}f ( {\tilde{b}}_{k , s} ( n ) ) = tanh ( {\tilde{b}}_{k , s} ( n ) ) , & if s = 1 , \\ \begin{matrix}f ( {\tilde{b}}_{k , s - 1} ( n ) , {\tilde{b}}_{k , s} ( n ) ) = tanh ( \frac{\begin{matrix}sign ( {\tilde{b}}_{k , s - 1} ( n ) ) + \\ sign ( {\tilde{b}}_{k , s} ( n ) )\end{matrix}}{2} ) \\ = 0.7 \; 6 \; 1 \; 6 ( \frac{\begin{matrix}sign ( {\tilde{b}}_{k , s - 1} ( n ) ) + \\ sign ( {\tilde{b}}_{k , s} ( n ) )\end{matrix}}{2} ) ,\end{matrix} & if 1 < s < {N}_{s} , \\ f ( {\tilde{b}}_{k , s} ( n ) ) = sign ( {\tilde{b}}_{k , s} ( n ) ) , & if s = {N}_{s} .\end{matrix} \qquad ( 20 )$$

In the first stage 32₁, for example, a tangent-hyperbolic function 41 can be used. Such a function would softly limit the estimated information (binary) to within the pre-assumed safe dynamics. On the other hand at the last Nₛ stage 32, a hard decision is made. However, to delimit the flip-flop effect [8], for 1<s<Nₛ, a decision function operates on the current and the previous filter outputs, namely, \tilde{b}_{k,s}(n) and \tilde{b}_{k,s-1}(n) from Equation (20). In fact, the outcome from (sign(\tilde{b}_{k,s-1}(n))+sign(\tilde{b}_{k,s}(n)))/2 is −1, 1 or 0. If the outcome is +1 or −1, this means that both the s^{th} and (s−1)^{th} stages 32 agree that +1 or −1 has been transmitted, respectively. On the other hand, a 0 outcome signals a flip-flop phenomena and the hard estimates are not involved in the ICB 36 in the s^{th} stage 32 procedure (the related interference is not constructed nor eliminated which prevents an erroneous decision from propagating to the next (S+1)^{th} stage 32. Applying the tangent-hyperbolic function on (sign(\tilde{b}_{k,s-1}(n))+sign(\tilde{b}_{k,s}(n)))/2 reduces to multiplying by 0.7616, since tan h(±1)=±0.7616.

B) Interference Cancellation Block (ICB)

Furthermore, for a more effective MAI and ISI cancellation, the ICB 36 should be used in a cascade arrangement such as illustrated in FIG. 2. The ICB 36 regenerates all or part of the users' contributions using the outputs 44 of the AFB 34. Once the interference cancellation procedure is performed over the received spread spectrum signal y(t; n), through one stage 32 of the multi-stage ADIC 30 and resulting in an essentially interference-free signal per user 12, this essentially interference-free signal is fed to the AFB 34 of the next (s+1)^{th} stage 32. The ICB 36 also performs re-spreading and interference cancellation by receiving as inputs the estimates 44 of the information traffic sequence from the AFB 34 and outputs an estimated version of the received signal y(t; n) [3] as illustrated in FIG. 2.

Actually, the AFB outputs 44 {\hat{b}_{k,s}(n)}ₙ₌₁^{N} from Equation (18) constitute the inputs of the ICB 36. The main purpose of the ICB 36 is to eliminate MAI. For a given stage 32, first the ICB 36 constructs the k^{th} user contribution z_{k,s}(t; n) using Equation (21). This process is identical to Equation (5) [9]. However, unlike Equation (5), in this case, the channel information such as Aₖ, h_{k,p}(n) and the delays τ_{k,p}, for 1≦k≦K and 1≦p≦Pₖ, are provided by the channel estimator 52. The re-spreading process, yielding z_{k,s}(t; n), is given by:

$$\begin{matrix}{z}_{k , s} ( t ; n ) = {\hat{A}}_{k} {\hat{b}}_{k , s} ( n ) {\sum }_{p = 1}^{{P}_{k}} {\hat{h}}_{k , p} ( n ) {d}_{k} ( t - nT - {\hat{τ}}_{k , p} ; n ) \\ = {\hat{A}}_{k} {\hat{b}}_{k , s} ( n ) {\hat{Θ}}_{k} ( t ; n )\end{matrix} \qquad ( 21 )$$

Accordingly, the total contributions from all the K users is given by the summation of all the users' contributions, such that:

$${Z}_{s} ( t ; n ) = {\sum }_{k = 1}^{K} {z}_{k , s} ( t ; n ) \qquad ( 22 )$$

Therefore, the k^{th} user's interference can be deduced as:

ζ_{k,s}(t;n)=Zₛ(t;n)−z_{k,s}(t;n) (23)

Then, the input 42 of the next (s+1)^{th} stage 32 is built by using the received signal from Equation (4) and the pre-estimated interference from Equation (13) as follows:

ŷ_{k,s}(t;n)=y(t;n)−ζ_{k,s}(t;n) (24)

where {ŷ_{k,s}(t; n)}ₙ₌₁^{N} constitute the estimates of the received spread spectrum signals, essentially free from MAI and ISI.

The filtering weights 40 are designed, as described hereinabove, and duplicated over all the stages 32.

Turning now to FIG. 6, the detection process 200 of the transmitted signals is illustrated for one stage 32 of the multi-stage ADIC 30. During operation 202, the adaptive filters 340 of the AFB 34 receives at its input the received spread spectrum signal as given in Equation (16) if the current stage 32 is the first stage of the multi-stage ADIC 30, or an estimated spread signal as given by Equation (17) for the rest of the stages 32 of the multi-stage ADIC 30.

During operation 204, a raw estimate \tilde{b}_{k,s}(n) given by Equation (18) of the transmitted traffic information symbols is obtained from the spread spectrum signal through the adaptive filters 340 of the AFB 34 with the adapted weights 40.

Then, during operation 206, using a decision function, a refined version {\hat{b}_{k,s(n)}}ₙ₌₁^{N} of the estimates of the transmitted information symbols is calculated according to Equation (20).

During operation 208, a re-spread signal is computed using the refined information symbols, according to Equation (21). Then, during operation 210, the contribution of all the K users is computed, by summing together the re-spread signal from the K users according to Equation (22).

During operation 212, the interference to the user k of interest is estimated according to Equation (23).

Finally, during operation 214, the estimate of the spread spectrum signal received by the user k is calculated according to Equation (24).

This estimate is the output of the ICB 36 and is essentially free from MAI and ISI. For even better results, the estimate is passed through a plurality of stages 32 for eliminating MAI and ISI. Therefore, the greater is the number of stages 32, the better are the results of detecting and decoding the transmitted signals.

### Multiple Antenna Environments

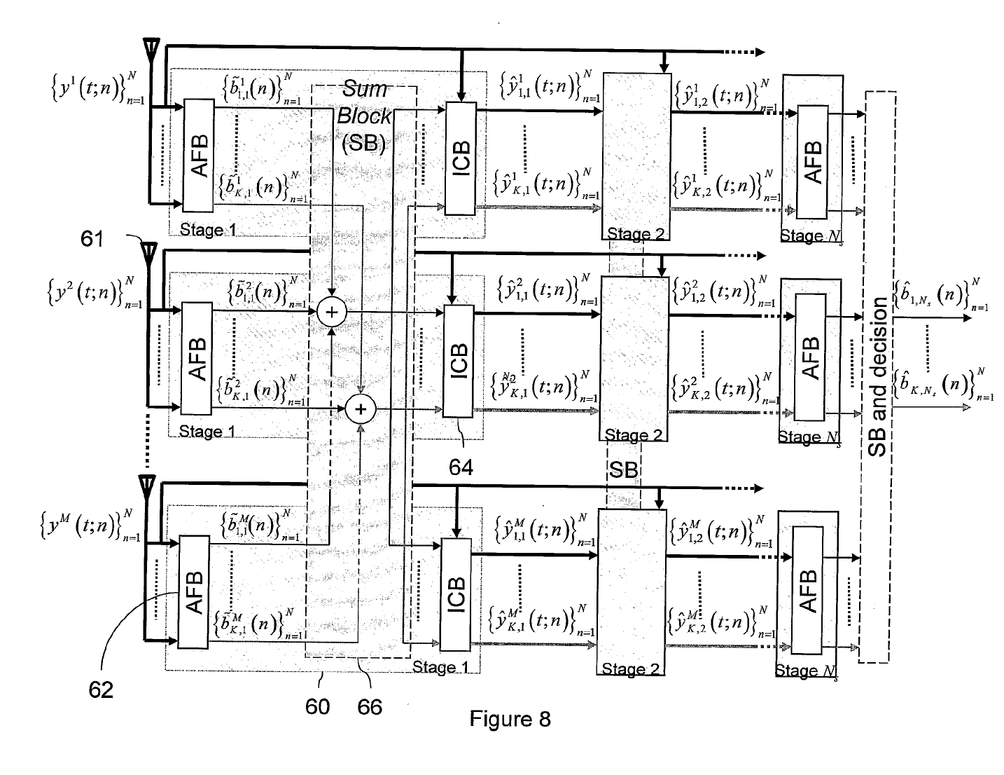

FIG. 8 illustrates a second version of a multi-stage ADIC 60, which is tailored to operate in a multiple receiving antenna environment [3], with a number M of receiving antenna 61. Basically, the ADIC 60 remains technically unchanged as compared to the first version as described hereinabove. The ADIC 60 is duplicated over the M receiving antenna 61. Each ADIC 60 comprises an AFB 62 and an ICB 64 for suppressing ISI and eliminating MAI. Regarding the operational phases such as the adaptation and detection phases, they are also performed in a same way as seen previously, for each receiving antenna. For example, the adaptation phase per sub-filter is carried out for each antenna m, for a total of M antennas 61. Therefore, one would account for a sequence of M filtering weights in total, {{wₖ^{m}}ₖ₌₁^{K}}ₘ₌₁^{M} (not shown). During the detection phase, the M received signals {{y^{m}(t; n)}ₙ₌₁^{N}}ₘ₌₁^{M} are passed through their respective AFB 62 in the first stage, in order to produce the estimates, {{\tilde{b}_{k,1}^{m}(t; n)}ₙ₌₁^{N}}ₘ₌₁^{M}, of the traffic information sequences. However, prior to entering the ICB 64, the adaptive filter outputs {{\tilde{b}_{k,1}^{m}(t; n)}ₙ₌₁^{N}}ₘ₌₁^{M} are not directly fed to the ICB 64. Taking advantage of the receiving antenna diversity (since M>1), these M outputs are first weighted and summed in a sum block (SB) or combiner block 66. Expression (25) presents a simple implementation of the summation operation performed by the sum block (SB) 66, with all the weights set to one, and is given as follows:

$${Q}_{k , s} ( t ; n ) = {\sum }_{m = 1}^{M} {\tilde{b}}_{k , s}^{m} ( t ; n ) {\breve{y}}_{k}^{( synth )} [ n ] {-}^{Δ} {[ \begin{matrix}real {( {y}_{k}^{( synth )} [ n ] )}^{T} , \\ {imag ( {y}_{k}^{( synth )} [ n ] )}^{T}\end{matrix} ]}^{T} \qquad ( 25 )$$

where 1≦n≦N, 1≦k≦K, 1≦s≦Nₛ and 1≦m≦M.

Then, the normal operations of the ICB 64 as seen in Equations (21)-(24), for a stage s of a receiving antenna m, are performed but using the summation Q_{k,s}(t; n) as defined in Equation (25). It should be noted that special attention should be given to the input signals of the ADIC 60 and the channel information per antenna 61, since they are different from one antenna to another. This is carried from one stage to another. Also, notice that for a multiple receiving antenna environment, a smaller number of stages is implemented, for example 3 or less. In contrast, in the case of a single receiving antenna environment, a larger number of stages are implemented, for example 5 stages. As regard to the last stage, it consists of one AFB 62 per user per antenna and one SB 66 per user.

### Implementation Complexity

### A) Complexity Results

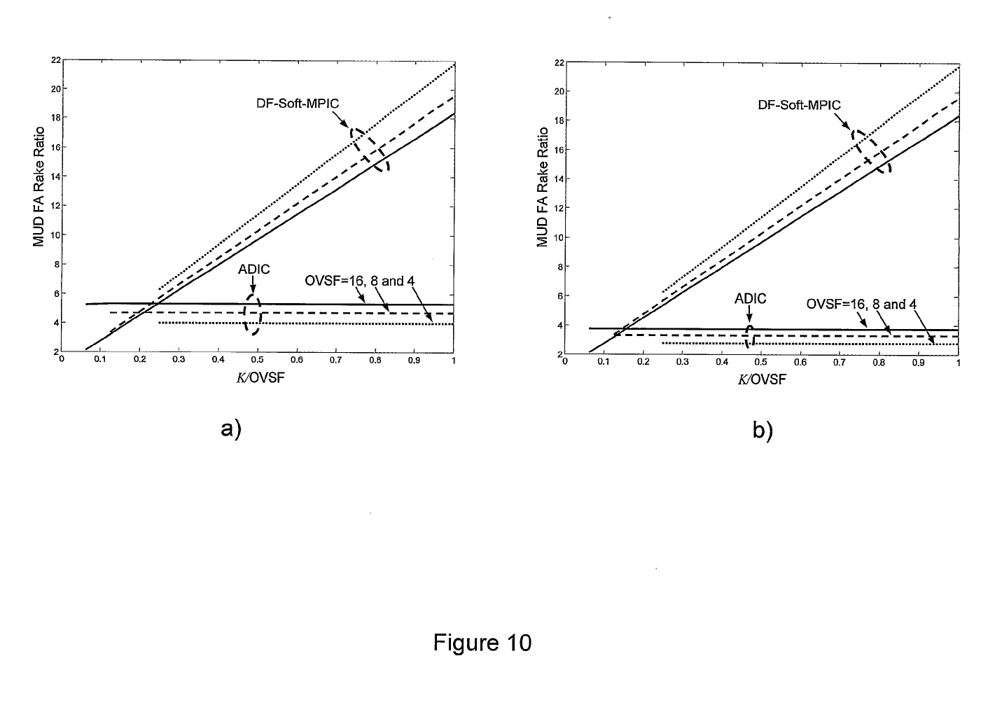

In order to make a fair arithmetic complexity comparison, a unified framework for all these techniques can be used by considering an elementary arithmetic unit used to realize an adder and a multiplier, the number of full adders (FA). In a VLSI technology, multiplication and addition operations have the same binary structure with a bit word-length adjusted to assure the precision needed. It is considered that an addition requires N_{q} FA and a multiplication N_{q}² FA, N_{q} being the number of bits needed to quantify each parameter of MUD studies. The required number of FA for ADIC and DF-Soft-MPIC (Decision Feedback Multi-Stage Interference Cancellor) relative to the Rake receiver for N_{c}=16, 8 and 4 (in WCDMA, OVSF=16, 8 and 4 respectively) is shown FIG. 10. There are considered, in FIG. 10a) 15 updates (adaptation phase) per frame (each slot), Nₛ=3 and N_{q}=16 bits. The Rake and DF-Soft-MPIC receivers have no adaptation step, but the effective code and the correlation matrix computation are considered as adaptation phase.

It is known that the commercial key component of MUD method consist of a low implementation complexity [3] to attain the desired performance. The adaptive approach proposed by ADIC makes possible to fine tune the performance-complexity tradeoff. For example, performances (gain in dB) of ADIC reach the performance of DF-Soft-MPIC by reducing at 8 adaptation phase per frame, as illustrated in FIG. 10b.

At full-load system K=N_{c}, FIG. 10b reveals that the DF-Soft-MPIC is 20 times more complex than the conventional Rake receiver while ADIC is no more than 4 times more complex. For K=N_{c}, we can notice that ADIC presents a 4 to 7 complexity reduction compared to the DF-soft-MPIC.

### B) Beyond the Arithmetic Complexity

Another important aspect to compare the implementation complexity is the algorithmic structure such as regularity, recursiveness, data flow, memory quantity and inherent parallelism—all qualities intrinsic to the non restrictive illustrative embodiments of the present invention.

In this study, these aspects have not been included to compare MUD methods. However, an obvious consideration can be observed with the decision feedback structure of MUD. Indeed, even if the decision feedback structure might have relatively the same complexity level, the main drawback is the lack of parallelism that can be exploited, especially for the MPIC caused by data dependencies. In fact, a DF-MPIC at instant n and for user k needs to wait for all users so that the k^{th} user proceeds to detect the current data before processing its own data. Such a structure looses its parallelism to apply pipeline or parallel techniques and to become serial operation limited for sequential DSP implementation. Hence, the DF-MPIC will always be limited by the DSP clock speed to respect the computational time imposed by the 3GPP time frame. Noted that, the present invention do not use decision feedback structure to exploit the parallel implementation techniques.

Decision feedback techniques such as the one illustrated in FIG. 7 can be used to improve the performance.

When 3≦Nₛ≦5, it is worth mentioning that the ADIC 30 can be optimized for a better performance-complexity trade-off. The performance represents the gains in dB saved to target a Bit Error Rate compared to the reference method and the complexity represents the implementation cost into VLSI technology such as DSP (Digital Signal Processor, FPGA—Field Programmable Gate Array, ASIC—Application Specific Integrated Circuit). Inherent to the illustrative embodiments of the present invention is a flexibility to tune the performance-complexity tradeoff based on the parameters such as N_{synth} and Nₛ. Compared to the most known technique, DF-Soft-MPIC, the same performance in dB are obtained with less complexity in terms of arithmetic implementations (see the results in the next section).

### Simulation Results

Experiments have been conducted in a WCDMA environment using the above described non-restrictive illustrative embodiment according to the present invention. The experiment conditions are presented in appended Table 1, with one receiving antenna 14. For the sake of reference and comparison, the Rake receiver, DF-Hard-MPIC and DF-Soft-MPIC [2], [3], [25], [26] are included.

TABLE 1
WCDMA Simulation Conditions

| | |
|---|---|
| Number of users | K = 15 |
| Spreading factor (OVSF) | N_{c} = 16 and 8 (64 kb/s and 144 kb/s) |
| Pulse-shaping filter | Raised cosine, roll off factor: 0.22 |
| Channel type | Vehicular A, Pₖ = 6 paths for |
| | k = 1, 2, . . . , K |
| Mobile speeds | 3 km/h |
| Carrier frequency | 2 GHz |
| Nb of transmitting antennas | 1 |
| Nb of receiving antennas | M = 1 |
| Channel estimation type | Correlator [30] |
| Finger search | Perfect |
| Nb of fingers (Rake) | 4 |
| Pilot signal | Present in transmission and |
| | Canceled at the receiver |
| Receivers Methods | Rake, DF-Soft-MPIC and DF-Hard-MPIC |
| | and ADIC (invention) |

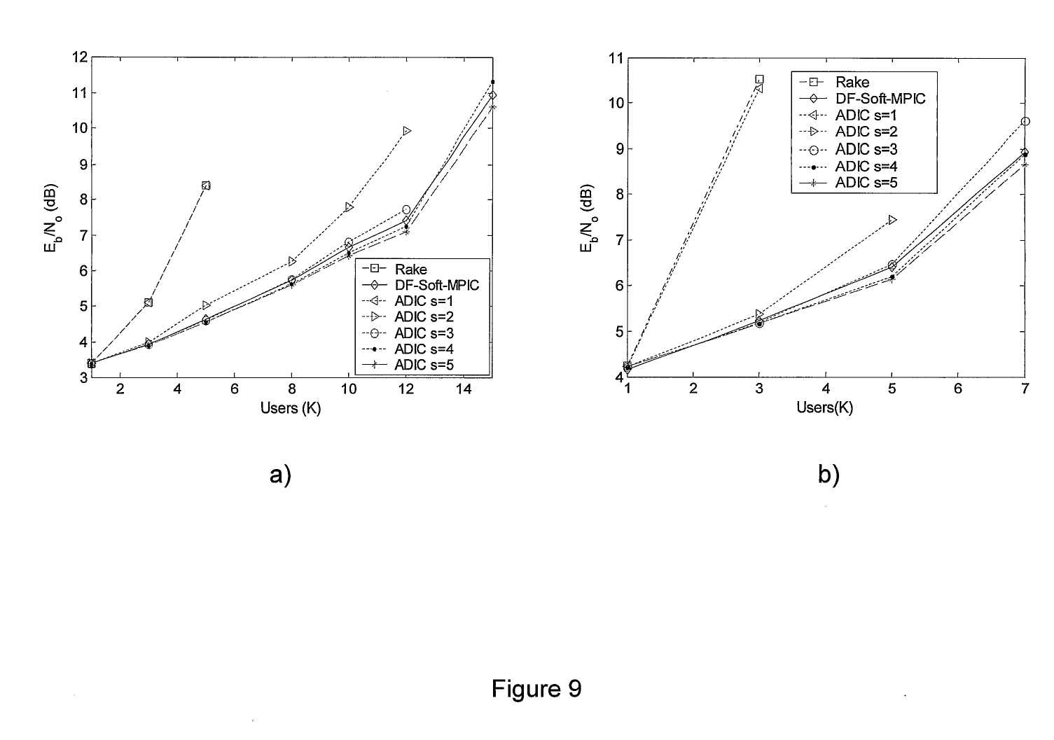

In order to obtain ADIC performances, we simulate receivers for two transmission rates OVSF 16 (64 kb/s) and 8 (144 kb/s) as shown in FIG. 9. Considering N_{c} of 16 and 8 we have, respectively, ADIC sub-filters length, N_{SF}, of 32 and 16. The number of synthesized symbols, N_{synth}, is 320 and 640 per slot. For all simulations, 6000 slots worth of data are used to generate the BER results in all figures. The AFB 34 uses the SM-NLMS adaptation rule with λ=0.005 and the DF-Soft-MPIC has 5 stages. The pilot-transmission signals are included in the transmission signal as given in Equation (4) but is canceled from the received spread spectrum signal at the receiving antenna 14 by applying a pilot suppression method (e.g. [28]) for all users before applying the MUD methods.

FIG. 9 shows the performance results in terms of signal to noise ratio (E_{b}/N₀) versus the number of users for two transmission rates 64 kb/s and 144 kb/s. In both cases, the fifth stage of ADIC 30 gives BERs equivalent (at high noise level) or better than DF-Soft-MPIC. Performance-wise, ADIC MUD can be tailored to work with Nₛ=3 stages while maintaining good performance-complexity trade offs. It is worth mentioning that ADIC MUD provides the same results as the Rake at the first stage (s=1).

As depicted in FIG. 10, the ADIC 30 for MUD offers a good performance complexity trade-off at a complexity of at least three to seven times lower than that of DF-Hard-MPIC (Decision Feedback Hard Multi-Stage Interference Cancellor) or DF-soft-MPIC (Decision Feedback Soft Multi-Stage Interference Cancellor). For both DF-hard-MPIC and DF-Soft-MPIC methods, five stages are used to obtain these results. It is also observed that the greater is the number of stages 32, the better is the performance, as shown in FIG. 9 wherein the BER decreases as the number of stages 32 of the multi-stage ADIC 30 increases. At less than 1 dB loss, at a very low complexity, only three stages could be used.

Furthermore, experimental results dictated that N_{synth}=2N symbols per slot (a slot is worth N=2560/N_{c} symbols, for N_{c}=16, N=160 bits) per user to yield a sufficient AFB performance. This is valid for any spreading code length, multi-rate signaling and with the presence or suppression of the pilot-transmission signals as given in Equation (4).

Although the present invention has been described in the foregoing description by means of non-restrictive illustrative embodiments thereof, these illustrative embodiments can be modified at will within the scope of the appended claims without departing from the spirit and nature of the subject invention.

### REFERENCES

[1] R. Prasad and T. Ojanpera, “An overview of CDMA Evolution Toward Wideband CDMA,” IEEE Commun. Surveys, Vol. 1, No. 1, pp. 2-29, 1998.
[2] S. Moshavi, “Multiuser detection for DS-CDMA communications,” IEEE Communications Magazine, Vol. 34, No. 10, pp. 124-136, 1996.
[3] J. G. Andrews, “Interference Cancellation for Cellular Systems: A Contemporary Overview,” IEEE Wireless Comm., pp. 19-29, April 2005.
[4] S. L. Miller, “An Adaptive Direct-Sequence Code-Division Multiple-Access Receiver for Multiuser Interference Rejection,” IEEE Transaction on Communications, Vol. 43, No. 2/3/4, February/March/April 1995, pp. 1746-1755.
[5] S. L. Miller “Training Analysis of Adaptive Interference Suppression for Direct-Sequence Code-Division Multiple-Access Systems,” IEEE Transaction on Communications, Vol. 44, No. 4, April 1996, pp. 488-495.
[6] Y. Guo and J. R. Cavallaro, “A low complexity and lower Power SoC Design Architecture for Adaptive MAI Suppression in CDMA systems,” Journal of VLSI Signal Processing 44, 2006, pp. 195-217.
[7] S. Abedi and R. Tafazolli, “Genetically Modified Multiuser Detection for Code Detection Division Multiple Access Systems,” IEEE Journal on Selected Areas in Communications, Vol. 20, No. 2, February 2002, pp. 463-473.
[8] A. L. C. Hui and K. B. Letaief, “Successive Interference Cancellation for Multiuser Asynchronous DS/CDMA Devices in Multipath Fading Links,” IEEE Transaction on Communications, Vol. 46, No. 3, March 1998, pp. 384-391.
[9] G. Xue, J. Weng, T. Le-Ngoc and S. Tahar, “Adaptive Multistage Parallel Interference Cancellation for CDMA,” IEEE Journal on Selected Areas Communications, Vol. 17, No. 10, October 1999, pp. 1815-1827.
[10] S. Haykin, Adaptive Filter, 3^{rd} Edition, Prentice Hall, 1996.
[11] S. Gollamudi, S. Nagaraj, S. Kapoor, and Y. F. Huang, “Set-membership filtering and a set-membership normalized LMS algorithm with an adaptive step size,” IEEE Signal Processing Letters, Vol. 5, No. 5, pp. 111-114, May 1998.
[12] S. Werner. M. L. R. Campos and P. S. R. Diniz, “Partial-Update NLMS Algorithms with Data-Selective Updating,” IEEE Transaction on Signal Processing Vol. 52, No. 4, pp. 938-949, April 2004.
[13] S. Buzzi, M. Lops, A. M. Tulino, “A Generalized Minimum-Mean-Output-Energy Strategy for CDMA Systems with Improper MAI”, IEEE Transactions on Information Theory, Vol. 48, No 3, pp. 761-767, March 2002.
[14] Q.-T. Ho, D. Massicotte, A. O. Dahmane, “A Low Complexity Adaptive Multiuser Device and FPGA Implementation for Wireless DS-WCDMA Communication Systems,” EURASIP Journal on Applied Signal Processing—Designs Methods for DSP Systems, 2005.
[15] M. K. Varanasi and B. Aazhang, “Multistage detection in asynchronous code-division multiple-access communications,” IEEE Transactions on Communications, vol. 38, no. 4, pp. 509-519, April 1990.
[16] S. Verdú, “Minimum probability of error for asynchronous Gaussian multiple-access channels,” IEEE Transactions on Information Theory, vol. IT-32, no. 1, pp. 85-96, January 1986.
[17] A. J. Viterbi, CDMA: Principles of Spread Spectrum Communication, Addison-Wesley Publishing Company, 1995.
[18] R. Lupas and S. Verdú, “Linear multiuser devices for synchronous code-division multiple-access channels,” IEEE Transactions on Information Theory, vol. 35, no. 1, pp. 123-136, January 1989.
[19] R. Lupas and S. Verdú, “Near-far resistance of multiuser devices in asynchronous channels,” IEEE Transactions on Communications, vol. 38, no. 4, pp. 496-508, April 1990.
[20] U. Madhow and M. L. Honig, “MMSE interference suppression for direct sequence spread-spectrum CDMA,” IEEE Transactions on Communications, vol. 42, no. 12, pp. 3178-3188, December 1994.
[21] R. L. Pickholtz, D. L. Schilling, and L. B. Milstein, “Theory of spread-spectrum communications—A tutorial,” IEEE Transactions on Communications, vol. 30, no. 5, pp. 855-884, May 1982.
[22] J. G. Proakis, Digital communications, WCB/McGraw-Hill, 3rd Ed., 1995.
[23] Z. Xie, R. T. Short, and C. K. Rushforth, “A family of suboptimum devices for coherent multi-user communications,” IEEE Journal on Selected Areas in Communications, vol. 8, no. 4, pp. 683-690, May 1990.
[24] Z. Zvonar and D. Brady, “Linear multipath-decorrelating receivers for CDMA frequency-selective fading channels,” IEEE Transactions on Communications, vol. 44, no. 6, pp. 650-653, June 1996.
[25] L. Yue-Heng, C. Ming and C. Shi-Xin, “Decision feedback partial parallel interference cancellation for DS-CDMA,” 21st Century Military Communications Conference Proceedings (MILCOM 2000), Vol. 1, pp. 579-582, 22-25 Oct. 2000.
[26] H. Chenghua, Y. Tang, L. Shaoqian and L. Zhongling, “Weight-optimizing partial parallel interference cancellation based on channel estimation for CDMA systems in fading channels,” IEEE 58th Vehicular Technology Conference VTC 2003-Fall, Vol. 2, pp. 1099-1103, 6-9 Oct. 2003.
[27] D. Massicotte, A. O. Dahmane, “Cascade Filters Receiver for DS-CDMA Communication Systems”, WO04040789, 13 May 2004.
[28] D. Massicotte, A. O. Dahmane, “Mixed Direct-indirect Adaptation Procedure Applied to Receiver Filter”, WO04105264, 2 Dec. 2004.
[29] D. Massicotte, M. Ahmed-Ouameur, “Method and System for Multi-User Channel Estimation in DS-CDMA Systems”, WO2005099130, 20 Oct. 2005.
[30] F. Ling, “Coherent detection with reference symbol based channel estimation for direct sequence CDMA uplink communication”, in Proc. Vehicular Technology Conf., pp. 400-403, May 1993.
[31] M. Ahmed-Ouameur, D. Massicotte, “Wiener LMS Based Multipath Channel Estimation in WCDMA and CDMA2000”, IEEE-Vehicular Technology Conference, Montreal, September 2006.

What is claimed is:

1. A device for substantially cancelling at least Multiple Access Interference (MAI) and Inter-Symbol Interference (ISI) while detecting a received spread spectrum signal in a multi-user communication system, the device comprising:
a plurality of stages, each comprising:
means for filtering the received spread spectrum signal through an interference cancelling function to produce an essentially MAI- and ISI-free signal; and
means for processing the essentially MAI- and ISI free signal through a reconstruct received spread spectrum signal function to produce a received spread spectrum signal essentially free from MAI and ISI;
wherein the plurality of stages are cascaded to successively process the spread spectrum signal and improve cancellation of MAI and ISI from the spread spectrum signal.

2. A device for substantially cancelling at least Multiple Access Interference (MAI) and Inter-Symbol Interference (ISI) while detecting a received spread spectrum signal in a multi-user communication system, this device comprising:
a plurality of stages, each comprising:
at least one adaptive filter for filtering the received spread spectrum signal through an interference cancelling function to produce an essentially MAI- and ISI-free signal; and
an interference cancellor, connected to the at least one adaptive filter, for processing the essentially MAI- and ISI-free signal through a reconstruct received spread spectrum signal function to produce a received spread spectrum signal essentially free from MAI and ISI;
wherein the plurality of stages are cascaded to successively process the spread spectrum signal and improve cancellation of MAI and ISI from the spread spectrum signal.

3. A device as defined in claim 2, wherein each adaptive filter comprises filtering weights.

4. A device as defined in claim 3, further comprising a training signal generator to produce a training signal, wherein the adaptive filter adapts the filtering weights in relation to the training signal.

5. A device as defined in claim 4, wherein the training signal comprises training symbols from an alphabet.

6. A device as defined in claim 5, wherein the training signal generator randomly generates the training symbols from the alphabet.

7. A device as defined in claim 5, wherein the training signal generator generates the training symbols according to a given distribution.

8. A device as defined in claim 4, wherein the training signal generator comprises a channel estimator for estimating channel information.

9. A device as defined in claim 8, wherein the estimated channel information comprise a delay and an attenuation of the channel.

10. A device as defined in claim 3, wherein the adaptive filter adapts the filtering weights through an adaptive and iterative technique.

11. A device as defined in claim 10, wherein the adaptive and iterative technique is selected from the group comprising a Least Mean Square (LMS) technique and a Set Membership Normalized Least Mean Square (SM-NLMS) technique.

12. A device as defined in claim 3, wherein each adaptive filter of the plurality of stages have the same filtering weights.

13. A device as defined in claim 2, wherein the at least one adaptive filter of each stage comprises a set of adaptive filters, wherein at least one of said adaptive filters is assigned to each user.

14. A device as defined in claim 2, wherein the interference cancellor produces outputs given by the following relation:
ŷ_{k,s}(t;n)=y(t;n)−ζ_{k,s}(t;n)
where k is an index referring to a k^{th} user, with 1≦k≦K, K being a total number of users, s is an index referring to a s^{th} stage, with 1≦s≦Nₛ, Nₛ being a total number of stages, t refers to time, n is an index referring to a n^{th} symbol, y(t; n) is a received spread spectrum signal, and ζ_{k,s}(t; n) refers to the MAI and ISI related to the k^{th} user.

15. A device as defined in claim 2, wherein the adaptive filter produces outputs corresponding to estimates of traffic information symbols.

16. A device as defined in claim 15, wherein the adaptive filter comprises a decision function to determine the estimates of the traffic information symbols.

17. A device as defined in claim 16, wherein the decision function comprises a signum function.

18. A device as defined in claim 16, wherein the decision function comprises a tangent-hyperbolic function.

19. A device as defined in claim 2, wherein the adaptive filter of each stage is supplied with an input signal selected from the group consisting of a received spread spectrum signal and an estimated version of the received spread spectrum signal from a preceding stage.

20. A device as defined in claim 2, wherein each interference cancellor of the plurality of stages comprises a function for calculating signal contributions from different users.

21. A device as defined in claim 20, wherein each interference cancellor comprises a function for calculating an interference signal related to a user of interest based on the signal contributions from the different users.

22. A device as defined in claim 21, wherein each interference cancellor further comprises a function for removing the interference signal from the received spread spectrum signal of the user of interest in order to reconstruct a received spread spectrum signal essentially free from MAI and ISI.

23. A method for substantially cancelling at least Multiple Access Interference (MAI) and Inter-Symbol Interference (ISI) while detecting a received spread spectrum signal in a multi-user communication system, the method comprising:
forming a plurality of stages, each comprising:
processing the received spread spectrum signal through an interference cancelling function to produce an essentially MAI- and ISI-free signal; and
processing the essentially MAI- and ISI-free signal through a reconstruct received spread spectrum signal function to produce a received spread spectrum signal essentially free from MAI and ISI; and
cascading the plurality of stages to successively process the spread spectrum signal and improve cancellation of MAI and ISI from the spread spectrum signal.

24. A method as defined in claim 23, wherein processing the received spread spectrum signal comprises filtering the received spread spectrum signal through at least one adaptive filter having filtering weights, and wherein filtering the received spread spectrum signal comprises adapting the filtering weights.

25. A method as defined in claim 24, wherein adapting the filtering weights comprises generating a training signal and adapting the filtering weights in relation to the training signal.

26. A method as defined in claim 25, wherein the training signal comprises training symbols from an alphabet.

27. A method as defined in claim 26, wherein generating the training signal comprises randomly generating the training symbols from the alphabet.

28. A method as defined in claim 26, wherein generating the training signal comprises generating the training symbols according to a given distribution.

29. A method as defined in claim 25, wherein generating the training signal comprises estimating channel information.

30. A method as defined in claim 29, wherein the estimated channel information comprise a delay and an attenuation of the channel.

31. A method as defined in claim 24, wherein the filtering weights are adapted through an adaptive and iterative technique.

32. A method as defined in claim 31, wherein the adaptive and iterative technique is selected from the group comprising a Least Mean Square (LMS) technique and a Set Membership Normalized Least Mean Square (SM-NLMS) technique.

33. A method as defined in claim 24, wherein filtering the received spread spectrum signal in the plurality of stages uses the same filtering weights.

34. A method as defined in claim 24, wherein the at least one adaptive filter of each stage comprises a set of adaptive filters, and wherein said method comprises assigning, in each stage, at least one adaptive filter of the set of adaptive filters to each user.

35. A method as defined in claim 23, wherein processing the essentially MAI- and ISI-free signal through the reconstruct received spread spectrum signal function comprises producing outputs given by the following relation:
ŷ_{k,s}(t;n)=y(t;n)−ζ_{k,s}(t;n)
where k is an index referring to a k^{th} user, with 1≦k≦K, K being a total number of users, s is an index referring to a s^{th} MAI and ISI cancelling stage, with 1≦s≦Nₛ, Nₛ, being a total number of MAI and ISI cancelling stages, t refers to time, n is an index referring to a n^{th} symbol, y(t; n) is a received spread spectrum signal, and (t; n) refers to the MAI and ISI related to the k^{th} user.

36. A method as defined in claim 24, wherein filtering the received spread spectrum signal comprises producing outputs corresponding to estimates of traffic information symbols.

37. A method as defined in claim 36, wherein filtering the received spread spectrum signal comprises using a decision function to determine the estimates of the traffic information symbols.

38. A method as defined in claim 37, wherein the decision function comprises a signum function.

39. A method as defined in claim 37, wherein the decision function comprises a tangent-hyperbolic function.

40. A method as defined in claim 23, wherein processing the essentially MAI- and ISI-free signal through a reconstruct received spread spectrum signal function comprises:
calculating signal contributions from different users;
calculating an interference signal related to a user of interest based on the signal contributions from the different users; and
removing the interference signal from the received spread spectrum signal of the user of interest in order to produce a received spread spectrum signal essentially free from MAI and ISI.

41. A device as defined in claim 2, wherein the plurality of cascaded stages comprises a last stage comprising only the adaptive filter.

42. A method as defined in claim 23, wherein forming a plurality of stages comprises forming a last stage comprising only processing the received spread spectrum signal through the interference cancelling function.

43. A device as defined in claim 2, wherein the at least one adaptive filter produces a set of outputs, and wherein the device further comprises a sum block adapted to produce summations of the set of outputs for supply as input signals to the interference cancellor.

44. A method as defined in claim 23, wherein processing the received spread spectrum signal comprises producing a set of outputs, and wherein the method further comprises producing summations of the set of outputs for supply as input signals to the processing through the reconstruct received spread spectrum signal function.

45. A device as defined in claim 13, wherein each adaptive filter implements an adaptation phase and a detection phase.

46. A device as defined in claim 45, wherein each adaptive filter for each user, in each stage, comprises a different input signal, with an exception for a first stage wherein the input signal is the same for every adaptive filter.

47. A device as defined in claim 46, wherein each different input signal comprises each user's received spread spectrum signal essentially free from MAI and ISI.

48. A device as defined in claim 46, wherein each adaptive filter comprises filtering weights, said device further comprises a training signal generator to produce a training signal for each user, in relation to which each adaptive filter adapts the filtering weights, in the adaptation phase, each adaptive filter receives the training signal of the corresponding user.

49. A device as defined in claims 48, wherein each training signal comprises a received spread spectrum synthesized signal.

50. A device as defined in claim 48, wherein the adaptation phase of each adaptive filter for each user is independent from each other.

51. A method as defined in claim 34, comprising implementing in each adaptive filter assigned to each user a detection phase and an adaptation phase.

52. A method as defined in claim 51, comprising receiving in each adaptive filter assigned to each user, in each stage, a different input signal, with an exception for a first stage wherein the input signal is the same for every adaptive filter.

53. A method as defined in claim 52, wherein each different input signal comprises each user's received spread spectrum signal essentially free from MAI and ISI.

54. A method as defined in claim 51, wherein, adapting the filtering weights comprises generating a training signal for each user and adapting the filtering weights in relation to each training signal, in the adaptation phase, receiving in each adaptive filter assigned to each user the training signal of the corresponding user.

55. A method as defined in claim 54, wherein each training signal comprises a received spread spectrum synthesized signal.

56. A method as defined in claim 54, wherein adaptation of each filter for each user is independent from each other.

57. A device for substantially cancelling at least Multiple Access Interference (MAI) and Inter-Symbol Interference (ISI) while detecting a received spread spectrum signal in a multi-user communication system, the device comprising:
a set of adaptive filters for filtering the received spread spectrum signal through an interference cancelling function to produce an essentially MAI- and ISI-free signal;
wherein at least one of said adaptive filters is assigned to each user.

58. A device as defined in claim 57, wherein each adaptive filter implements an adaptation phase and a detection phase.

59. A device as defined in claim 58, wherein each adaptive filter comprises filtering weights to be adapted during the adaptation phase.

59. A device as defined in claim 58, further comprising a training signal generator for producing a training signal for each user, wherein each adaptive filter adapts the filtering weights in relation to the training signal of the corresponding user.

60. A device as defined in claim 59, wherein the training generator comprises a channel estimator for estimating channel information
